(19) United States
(12) Patent Application Publication
(10) Pub. No.: US 2017/0025707 A1
(43) Pub. Date: Jan. 26, 2017

(54) Lithium-ion Batteries and Preparation Method Thereof

(71) Applicants: BASF Corporation, Florham Park, NJ (US); BASF Battery Materials (Suzhou) Co.,Ltd., Suzhou (CN)

(72) Inventors: Meimei Wu, Suzhou (CN); Xueshan Hu, Suzhou (CN)

(21) Appl. No.: 15/301,156

(22) PCT Filed: Apr. 4, 2014
(86) PCT No.: PCT/CN2014/074786

§ 371 Date: Sep. 30, 2016

(51) Int. Cl. H01M 10/0567; H01M 10/0568; H01M 10/0525; H01M 4/485; H01M 4/58; H01M 4/587; H01M 10/0569; H01M 4/38

(52) U.S. Cl. CPC H01M 10/0567; H01M 10/0569; H01M 10/0568; H01M 4/386; H01M 4/387; H01M 4/485; H01M 4/5825; H01M 4/587; H01M 10/0525; H01M 2300/0028

(57) ABSTRACT

The invention relates to a lithium-ion battery comprising: (1)a cathode comprising LiFePO₄; (2) an anode; and (3) an electrolyte comprising: (A) a lithium salt; (B) a non-aqueous organic solvent; and (C) an additive comprising a compound of formula I or formula II, wherein each R1 to R5 is independently H or C1-C10 alkyl, each Ar₁ to Ar₃ is independently aryl.

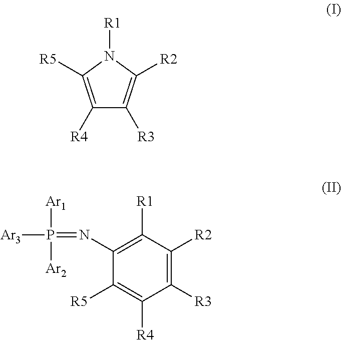

### FIELD OF THE INVENTION

The invention relates to lithium-ion batteries and a method of producing the lithium-ion batteries.

### DESCRIPTION OF RELATED ARTS

Recently, lithium-ion batteries have been widely used as high energy density sources in many consumer electronics as well as electric vehicles.

Impedance growth and capacity loss of lithium-ion batteries at elevated temperatures are still problems for obtaining high energy density sources. It is well known that impedance growth and capacity loss of lithium-ion batteries are mainly attributed to continued chemical and/or electrochemical reactions among electrolyte components, anode and cathode materials.

US2005/0019670 discloses non-aqueous electrolytes comprising stabilization additives, showing improved capacity retention at a temperature of 55° C. However, after 100 cycles, its cell system only shows capacity retention of no more than 75%, even no more than 60% (vide FIG. 3 and FIG. 4 of US2005/0019670).

Thus, there is a need to provide lithium-ion batteries having higher capacity retention at elevated temperature. The present invention provides a solution for excellent capacity retention after 1,000 cycles.

### SUMMARY OF THE INVENTION

For the purpose of the invention, the invention provides a lithium-ion battery comprising:

(1) a cathode comprising LiFePO₄;

(2) an anode; and

(3) an electrolyte comprising:
(A) a lithium salt;
(B) a non-aqueous organic solvent; and
(C) an additive comprising a compound of formula I or formula II of:

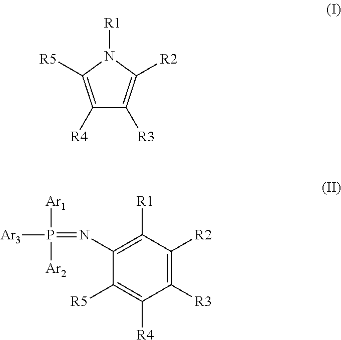

wherein each R1 to R5 is independently H or C1-C10 alkyl, each Ar₁ to Ar₃ is independently aryl.

The invention also provides a method for preparing such lithium-ion battery, the method comprises the steps of:

(1) injecting an electrolyte into a cell; and

(2) performing initial formation charge below a voltage of 3.9V.

It is found that the present lithium-ion batteries have good capacity retention at relative high temperature after 1,000 cycles.

### BRIEF DESCRIPTION OF DRAWINGS

FIG. 1 shows cycle curves of lithium-ion batteries according to example 1 and comparison example 1 after 1,000 cycles.

FIG. 2 shows cycle curves of lithium-ion batteries according to example 1, example 6 and comparison example 3 at 60° C. and 1 C.

FIG. 3 shows cycle curves of lithium-ion batteries according to example 7 and comparison example 1 after 1,000 cycles.

### EMBODIMENTS OF THE INVENTION

In one aspect, the invention provides a lithium-ion battery comprising:

(1) a cathode comprising LiFePO₄;

(2) an anode; and

(3) an electrolyte comprising:
(A) a lithium salt;
(B) a non-aqueous organic solvent; and
(C) an additive comprising a compound of formula I or formula II of:

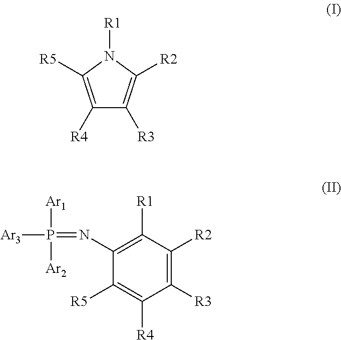

wherein each R1 to R5 is independently H or C1-C10 alkyl, each Ar₁ to Ar₃ is independently aryl.

Halo represents fluorine, chlorine, bromine, and iodine.

Preferably, the alkyl is C1-C8 alkyl, preferably C1-C4 alkyl. Alkyl includes linear or branched alkyl, and its non-limited examples include methyl, ethyl, propyl, butyl, pentyl, hexyl, heptyl, octyl, nonyl, decyl. Non-limited examples of branched alkyl include —CH(CH₃)₂, —CH(CH₃)(CH₂CH₃), —CH(CH₂CH₃)₂, —C(CH₃)₃, —C(CH₂CH₃)₃, —CH₂CH(CH₃)₂, —CH₂CH(CH₃)(CH₂CH₃), —CH₂CH(CH₂CH₃)₂, —CH₂C(CH₃)₃, —CH₂C(CH₂CH₃)₃, —CH(CH₃)CH(CH₃)CH₂CH₃), —CH₂CH₂CH(CH₃)₂, —CH₂CH₂CH(CH₃)(CH₂CH₃), —CH₂CH₂CH(CH₂CH₃)₂, —CH₂CH₂C(CH₃)₃, —CH₂CH₂C(CH₂CH₃)₃, —CH(CH₃)CH₂CH(CH₃)₂, —CH(CH₃)CH(CH₃)CH(CH₃)₂, —CH(CH₂CH₃)CH(CH₃)CH(CH₃)(CH₂CH₃).

In one preferred embodiment of the invention, each R1 to R5 is independently H or C1-C8 alkyl, preferably C1-C4 alkyl, more preferably methyl, ethyl, propyl, butyl.

Preferably, the aryl is substituted or unsubstituted C6-C10 aryl, such as phenyl, naphthyl, etc, more preferably phenyl. Examples of substituted aryl are C1-C4 alkyl substituted phenyl; C1-C4 alkoxy substituted phenyl; hydroxy, halogen or nitro substituted phenyl. Preferably, examples for alkyl substituted phenyl are ethylbenzene, toluene, xylene and its isomers, mesitylene or isopropylbenzene. Halogen substituted phenyl is for example chlorobenzene, bromobenzene, chlorotoluene or bromotoluene.

In one further embodiment of the invention, the content of the additive is 0.2-10 wt %, preferably 0.2-7 wt %, more preferably 0.2-5 wt % based on the total weight of the electrolyte.

In one embodiment of the invention, the additive (C) is formula (I), preferably N-methylpyrrole.

In one embodiment of the invention, the additive (C) is formula (II), wherein each Ar₁ to Ar₃ is independently C6-C10 aryl, preferably phenyl. Preferably, the compound of formulae II is N-(Triphenylphosphoranylidene)aniline.

In one further embodiment of the invention, a mixture of compounds of formulae I and formula II can be used.

In one preferred embodiment of the invention, the content of the compound of formula I or formula II is 0.2-10 wt %, preferably 1-10 wt %, more preferably 2-7 wt % based on the total weight of the electrolyte.

Preferably, the additive can further comprise vinylene carbonate (VC), 1,3-propane sultone (PS) or combination thereof. Preferably, the content of vinylene carbonate is 1-5 wt % based on the total weight of the electrolyte.

In one preferred embodiment of the invention, the additive consists of the compound of formulae I and vinylene carbonate, wherein the content of the compound of formulae I is 5-20 wt % based on the weight of the additive.

In one embodiment of the invention, the concentration of the lithium salt in the electrolyte is 0.5-2 mol/L, preferably 0.5-1.5 mol/L, more preferably 0.8-1.5 mol/L.

Preferably, the lithium salt is selected from the group consisting of lithium hexafluorophosphate (LiPF₆), lithium bis(oxalate)borate (LiBOB), lithium difluoro(oxalato)borate (LiODFB), lithium tetrafluoroborate (LiBF₄), lithium perchlorate (LiClO₄), lithium trifluoromethanesulfonate (LiCF₃SO₃), bis(trifluoromethane)sulfonimide lithium (LiTFSI) and combination thereof.

In more preferred embodiment of the invention, the lithium salt is selected from the group consisting of lithium hexafluorophosphate, lithium bis(oxalate)borate, lithium difluoro(oxalato)borate, lithium tetrafluoroborate and combination thereof. Particularly, the concentration of the lithium salt in the electrolyte is 0.8-1.5 mol/L.

In even more preferred embodiment of the invention, the lithium salt is selected from the group consisting of lithium hexafluorophosphate (LiPF₆), lithium tetrafluoroborate (LiBF₄) and combination thereof. More preferably, the lithium salt is a mixture of lithium hexafluorophosphate (LiPF₆) and lithium tetrafluoroborate (LiBF₄), and the total concentration of both is 0.5-2 mol/L, preferably 0.8-1.5 mol/L.

In one embodiment of the invention, the non-aqueous organic solvent is selected from the group consisting of ethylene carbonate (EC), propylene carbonate (PC), ethylmethyl carbonate (EMC), dimethyl carbonate (DMC), diethyl carbonate (DEC), γ-butyrolactone (GBL), methyl propyl carbonate (MPC), methyl formate (MF), ethyl formate (EF), methyl acetate (MA), ethyl acetate (EA), ethyl propionate (EP), ethyl butyrate (EB), acetonitrile (AN), N,N-dimethyllformamide (DMF) and combination thereof. The combination of two, three or more non-aqueous organic solvents above is preferred.

In one preferred embodiment of the invention, the non-aqueous organic solvent is a mixture of two or three solvents selected from the group consisting of ethylene carbonate (EC), propylene carbonate (PC), ethylmethyl carbonate (EMC), dimethyl carbonate (DMC), and diethyl carbonate (DEC). Preferably, the non-aqueous organic solvent comprises 5-20 wt % ethylene carbonate, 20-50 wt % ethylmethyl carbonate, and 20-60 wt % dimethyl carbonate.

In one embodiment of the invention, the cathode can also further comprise LiCoO₂, LiNiO₂, LiNi₁₋ₓCo_{y}Met_{z}O₂, LiMn_{0.5}Ni_{0.5}O₂, LiMn_{0.3}Co_{0.3}Ni_{0.3}O₂, LiMn₂O₄, LiFeO₂, LiMet_{0.5}Mn_{1.5}O₄, vanadium oxide, or mixtures of any two or more thereof, wherein Met is Al, Mg, Ti, B, Ga, Si, Ni, or Co, and wherein 0<x<0.3, 0<y<0.5, and 0<z<0.5.

In one embodiment of the invention, the anode comprises graphite, carbon, Li₄Ti₅O₁₂, tin alloys, silica alloys, intermetallic compounds, lithium metal, or mixtures of any two or more thereof.

In one preferred embodiment of the invention, the lithium-ion battery is lithium iron phosphate (LFP) battery.

The invention also provides a method for preparing such lithium-ion battery, the method comprises the steps of:

(1) injecting an electrolyte into a cell; and

(2) performing initial formation charge below a voltage of 3.9V.

In one preferred embodiment of the invention, the initial formation charge is performed in a range of 2.0-3.8V.

All percentages are mentioned by weight unless otherwise indicated.

### EXAMPLES

The present invention is illustrated by reference to the following examples, however, the examples are used for the purpose of explanation and not intended to limit the scopes of the invention.

### Example 1

The electrolyte solution is prepared in BRAUN glove box with argon gas of 99.999% purity and water content of ≦5 ppm at room temperature, wherein 12.77 g ethylene carbonate, 40.85 g ethylmethyl carbonate, 31.49 g dimethyl carbonate, 2 g vinylene carbonate and 0.2 g N-methylpyrrole are mixed evenly, and then LiPF₆ is added and mixed sufficiently to obtain 1.0 mol/L of LiPF₆ solution. The resulting electrolyte solution is injected into dried cell of lithium iron phosphate battery and placed for 18 to 24 hours, and then performing initial formation charge below a voltage of 3.9V in the battery cabinet.

### Example 2

The procedure of example 2 is similar to example 1, except that 12.73 g ethylene carbonate, 40.73 g ethylmethyl carbonate, 31.4 g dimethyl carbonate, 2 g vinylene carbonate and 0.5 g N-methylpyrrole are mixed evenly, and then LiPF₆ is added and mixed sufficiently to obtain 1.0 mol/L of LiPF₆ solution.

### Example 3

The procedure of example 3 is similar to example 1, except that 12.53 g ethylene carbonate, 40.10 g ethylmethyl carbonate, 30.91 g dimethyl carbonate, 2 g vinylene carbonate and 2 g N-methylpyrrole are mixed evenly, and then LiPF₆ is added and mixed sufficiently to obtain 1.0 mol/L of LiPF₆ solution.

### Example 4

The procedure of example 4 is similar to example 1, except that 12.66 g ethylene carbonate, 40.52 g ethylmethyl carbonate, 31.23 g dimethyl carbonate, 2 g vinylene carbonate and 1 g N-methylpyrrole are mixed evenly, and then LiPF₆ is added and mixed sufficiently to obtain 1.0 mol/L of LiPF₆ solution.

### Example 5

The procedure of example 5 is similar to example 1, except that 12.64 g ethylene carbonate, 40.44 g ethylmethyl carbonate, 31.17 g dimethyl carbonate, 2 g vinylene carbonate, 2 g N-methylpyrrole and 1 g 1,3-propane sultone are mixed evenly, and then LiPF₆ is added and mixed sufficiently to obtain 1.0 mol/L of LiPF₆ solution.

### Example 6

The procedure of example 6 is similar to example 1, except that 12.77 g ethylene carbonate, 40.85 g ethylmethyl carbonate, 31.49 g dimethyl carbonate, 2 g vinylene carbonate and 0.2 g N-methylpyrrole are mixed evenly, and then LiPF₆ is added and mixed sufficiently to obtain 1.0 mol/L of LiPF₆ solution. The resulting electrolyte solution is injected into dried cell of lithium iron phosphate battery and placed for 18 to 24 hours, and then performing initial formation charge below a voltage of 3.8V in the battery cabinet.

### Example 7

The procedure of example 7 is similar to example 1, except that 12.73 g ethylene carbonate, 40.73 g ethylmethyl carbonate, 31.4 g dimethyl carbonate, 2 g vinylene carbonate and 0.5 g N-(Triphenylphosphoranylidene)aniline are mixed evenly, and then LiPF₆ is added and mixed sufficiently to obtain 1.0 mol/L of LiPF₆ solution. The resulting electrolyte solution is injected into dried cell of lithium iron phosphate battery and placed for 18 to 24 hours, and then performing initial formation charge below a voltage of 3.9V in the battery cabinet.

### Example 8

The procedure of example 8 is similar to example 7, except that 12.66 g ethylene carbonate, 40.52 g ethylmethyl carbonate, 31.23 g dimethyl carbonate, 2 g vinylene carbonate and 1 g N-(Triphenylphosphoranylidene)aniline are mixed evenly, and then LiPF₆ is added and mixed sufficiently to obtain 1.0 mol/L of LiPF₆ solution.

### Comparison Example 1

The electrolyte solution is prepared in BRAUN glove box with argon gas of 99.999% purity and water content of <5 ppm at room temperature, wherein 12.79 g ethylene carbonate, 40.94 g ethylmethyl carbonate, 31.56 g dimethyl carbonate and 2 g vinylene carbonate are mixed evenly, and then LiPF₆ is added and mixed sufficiently to obtain 1.0 mol/L of LiPF₆ solution. The resulting electrolyte solution is injected into dried cell of lithium iron phosphate battery and placed for 18 to 24 hours, and then performing initial formation charge below a voltage of 3.9V in the battery cabinet.

### Comparison Example 2

The procedure of comparison example 2 is similar to comparison example 1, except that 12.66 g ethylene carbonate, 40.52 g ethylmethyl carbonate, 31.23 g dimethyl carbonate, 2 g vinylene carbonate, and 1 g 1,3-propane sultone are mixed evenly, and then LiPF₆ is added and mixed sufficiently to obtain 1.0 mol/L of LiPF₆ solution.

### Comparison Example 3

The procedure of comparison example 3 is similar to comparison example 1, except that 12.77 g ethylene carbonate, 40.85 g ethylmethyl carbonate, 31.49 g dimethyl carbonate, 2 g vinylene carbonate, and 0.2 g N-methylpyrrole are mixed evenly, and then LiPF₆ is added and mixed sufficiently to obtain 1.0 mol/L of LiPF6 solution. The resulting electrolyte solution is injected into dried cell of lithium iron phosphate battery and placed for 18 to 24 hours, and then performing initial formation charge below a voltage of 3.6V in the battery cabinet.

Test and Results

The dry cell comprises LiFePO₄ as cathode and artificial graphite (AG) as anode, purchased from WANXIANG EV CO., LTD and the design capacity of the lithium-ion battery is 4500 mAh. Dry cell is placed in the oven of 80-85° C. for 48 hours and then transferred to glove box for use.

The electrolyte solutions prepared according to examples and comparison examples are injected into dried cell, then remained for 24 hours, and are subjected to initial charging, vacuum sealing and formation to obtain the lithium ion batteries.

Performance Test

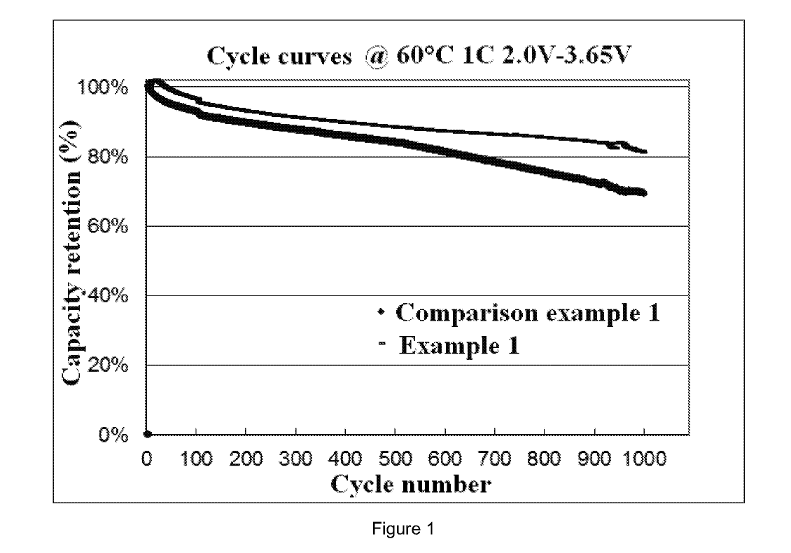

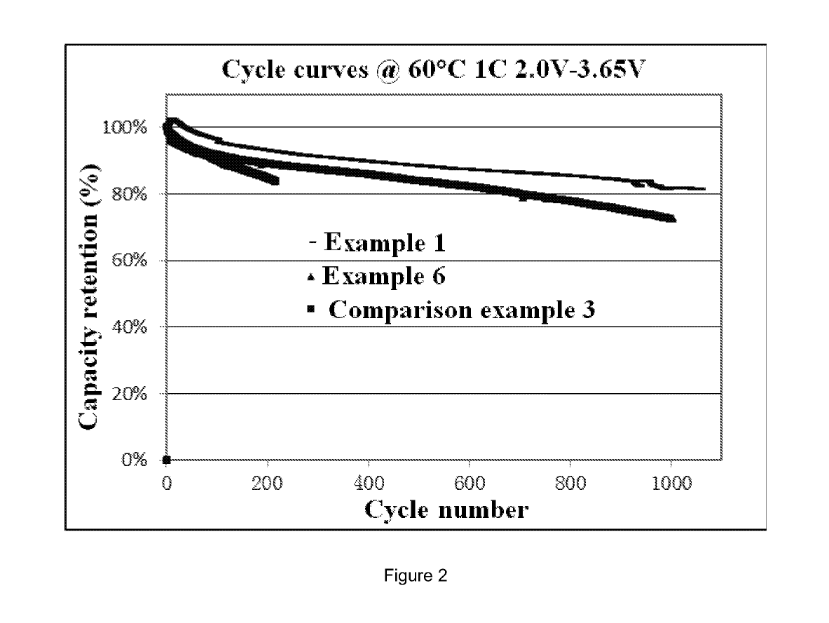

The lithium ion batteries are measured at 60° C./1 C cycle with cut-off voltage range of 2.0V-3.65V by using capacity test cabinet for lithium ion batteries (NEWARE CT-3008W-5V-6A). The results are shown in FIGS. 1 and 2.

FIG. 1 shows the comparison of cycling performances of LFP batteries at 60° C., and it indicates that the cycle capacity retention of the present LFP batteries is more than 80% after 1,000 cycles, while the cycle capacity retention of comparison example is less than 70% after 1,000 cycles.

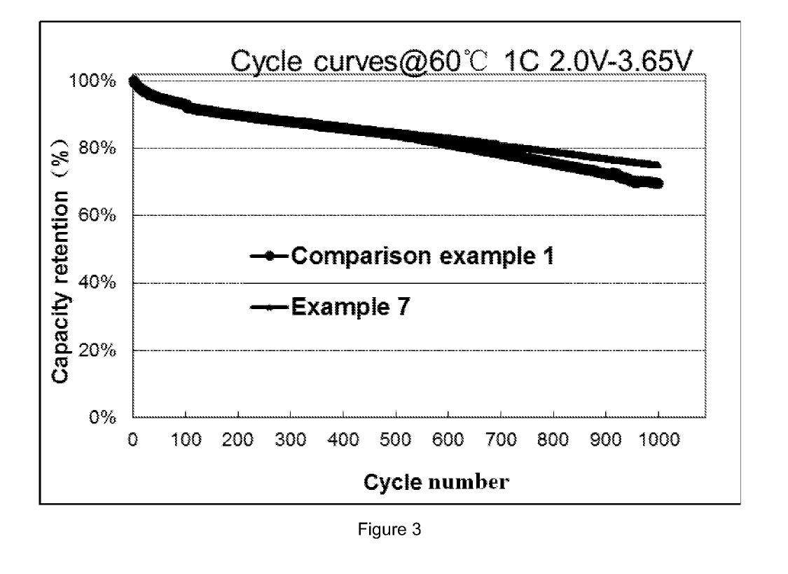

FIGS. 2 and 3 show that the cycle capacity retention according to the present invention is significantly greater than that of the lithium ion battery prepared according to the prior art.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1. A lithium-ion battery comprising:
(1) a cathode comprising LiFePO₄;
(2) an anode; and
(3) an electrolyte comprising:
(A) a lithium salt;
(B) a non-aqueous organic solvent; and
(C) an additive comprising a compound of formula I or formula II of: 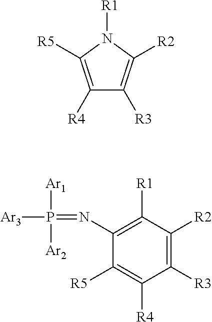
(I) (II) wherein each R1 to R5 is independently H or C1-C10 alkyl, each A₁ to Ar₃ is independently aryl.

2. The lithium-ion battery according to claim 1, wherein the electrolyte further comprises additives of vinylene carbonate (VC), 1,3-propane sultone (PS) or a combination thereof.

3. The lithium-ion battery according to claim 1, wherein the additive (C) is formula (I).

4. The lithium-ion battery according to claim 1, wherein each R1 to R5 is independently H or C1-C8 alkyl, preferably C1-C4 alkyl, more preferably methyl, ethyl, butyl.

5. The lithium-ion battery according to claim 4, wherein the compound of formula (I) is N-methylpyrrole.

6. The lithium-ion battery according to claim 1, wherein the additive (C) is formula (II), wherein each A to Ar₃ is independently C6-C10 aryl.

7. The lithium-ion battery according to claim 6, wherein the compound of formulae II is N-(Triphenylphosphoranylidene)aniline.

8. The lithium-ion battery according to claim 1, wherein the content of the additive (C) is 0.2-10 wt percent based on the total weight of the electrolyte.

9. The lithium-ion battery according to claim 1, wherein the lithium salt is selected from the group consisting of lithium hexafluorophosphate, lithium lithium difluoro(oxalato)borate, lithium tetrafluoroborate, lithium perchlorate, lithium trifluoromethanesulfonate, bis(trifluoromethane)sulfonimide lithium and combination thereof.

10. The lithium-ion battery according to claim 1, wherein the concentration of the lithium salt in the electrolyte is 0.5-2 mol/L.

11. The lithium-ion battery according to claim 1, wherein the non-aqueous organic solvent is selected from the group consisting of dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC) or mixtures thereof.

12. The lithium-ion battery according to claim 1, wherein the non-aqueous organic solvent comprises 5-20 wt percent ethylene carbonate, 20-50 wt percent ethylmethyl carbonate, 20-60 wt percent dimethyl carbonate.

13. The lithium-ion battery according to claim 1, wherein the anode comprises graphite, carbon, Li₄Ti₅Oi2, tin alloys, silica alloys, intermetallic compounds, lithium or mixtures of any two or more thereof.

14. A method for preparing a lithium-ion battery according to 1, the method comprises the steps of: (1) injecting an electrolyte into a cell; and (2) performing initial formation charge below a voltage of 3.9V.

15. The method according to claim 14, wherein the initial formation charge is performed in a range of 2.0-3.8V.
